(19) United States
(12) Patent Application Publication
(10) Pub. No.: US 2025/0049187 A1
(43) Pub. Date: Feb. 13, 2025

(54) BEVERAGE BOTTLE WITH DETACHABLE LOCKING MECHANISM FOR USE ON A LOCKER

(71) Applicants: JOSEPH BRIDGER CHRISTENSEN, CINCINNATI, OH (US); ETHAN MARK CHRISTENSEN, OGDEN, UT (US)

(72) Inventors: JOSEPH BRIDGER CHRISTENSEN, CINCINNATI, OH (US); ETHAN MARK CHRISTENSEN, OGDEN, UT (US)

(21) Appl. No.: 18/232,620

(22) Filed: Aug. 10, 2023

(51) Int. Cl. A45C 13/20; E05B 73/00

(52) U.S. Cl. CPC A45C 13/20; E05B 73/0005

(57) ABSTRACT

The invention provides a beverage bottle and, more specifically, a beverage bottle that incorporates either a chamber for housing a locking mechanism for securing a gym locker or a lock attachment feature for connection thereof to a bottle. This invention allows a user to securely lock their gym lockers while conveniently carrying their hydration source in a single, easily transportable item.

### FIELD OF THE INVENTION

The invention provides a beverage bottle and, more specifically, a beverage bottle that incorporates either a chamber for housing a locking mechanism for securing a gym locker or a lock attachment feature for connection thereof to a bottle.

### BACKGROUND OF THE INVENTION

It has been said that modern day gyms are among the least secure places for gym goers to store and secure their items, and gym lockers with no locks, the least secure of all.

Modern gym enthusiasts often face the inconvenience of carrying multiple items, such as gym bags, beverage bottles and locks for securing their belongings in a gym locker. The stories of “lost” or stolen valuable in and around gyms are legion. An easy fix, of course, is to combine two things that a gym goes needs: a water bottle and a lock to secure one's belongings in a gym locker.

### SUMMARY OF THE INVENTION

Accordingly, the invention provides a beverage bottle comprising a body having i) a first chamber suitable for storing liquid (for consumption by a user); ii) a second chamber positioned within the body; and at least one locking mechanism located within the second chamber, the locking mechanism being usable for securing a locker.

The beverage bottle herein preferably provides a second chamber that is concealed from external view. That second chamber is preferably completely enclosed and provides concealment of a locking mechanism therein via one or more kinds of latch mechanisms, screw mechanisms and/or pressure applied mechanisms.

In practice, the locking mechanism herein comprises a key-operated lock or a combination lock of the kind well known by persons of skill in the art. The locking mechanism is preferably further engageable with a latch system on a gym locker for securement thereof.

In one embodiment herein, the chamber of the beverage bottle is hidden or obscured by some sort of cover integrated into the body of the beverage bottle. The second chamber is then accessible via a removable cap or lid.

The latch system is connected to the locking mechanism via a linkage mechanism, allowing a user to control the lock from outside the beverage bottle. To be clear, the locking mechanism is detachable from the second chamber of the beverage bottle and then apply able to the latch of a locker, lock box and the like.

In a preferred embodiment herein, the locking mechanism of the beverage bottle may further comprise an indicator that is visible from the exterior of the beverage bottle, indicating whether the lock is engaged or disengaged.

The beverage bottle herein is preferably made of a durable and lightweight material such as plastic, metal, or some combination thereof.

In an alternative embodiment herein, the second chamber is either partially concealed or substantially not concealed at all. In this embodiment, the locking mechanism is attachable to the body of the bottle either in ready view from the bottle or out of view, for example, beneath the bottle in a concealed, partially concealed or substantially non-concealed second chamber of the bottle.

### BRIEF DESCRIPTION OF THE FIGURES

The various exemplary embodiments of the present invention, which will become more apparent as the description proceeds, are described in the following detailed description in conjunction with the accompanying drawings, in which:

FIG. 1 is a perspective view of one embodiment of the bottle and lock mechanism herein;

FIG. 2 is an exploded perspective view of the bottle and lock mechanism of FIG. 1;

FIG. 3 is a two-dimensional side-view of the bottle and lock mechanism here; and

FIG. 4 is a two dimensional view of the locking mechanism and its major constituent parts.

### DETAILED DESCRIPTION OF THE INVENTION

The following description is provided as an enabling teaching of the present systems, and/or methods in its best, currently known aspect. To this end, those skilled in the relevant art will recognize and appreciate that many changes can be made to the various aspects of the present systems, and/or methods described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a”, “an” and “the” include plural referents unless the context clearly dictates otherwise. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can”, “could”, “might”, or “may”, unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

The invention provides a beverage bottle comprising a body having i) a first chamber suitable for storing liquid (for consumption by a user); ii) a second chamber positioned within the body; and at least one locking mechanism located within the second chamber, the locking mechanism being usable for securing a locker.

The beverage bottle herein preferably provides a second chamber that is concealed from external view. That second chamber is preferably completely enclosed and provides concealment of a locking mechanism therein via one or more kinds of latch mechanisms, screw mechanisms and/or pressure applied mechanisms.

In practice, the locking mechanism herein comprises a key-operated lock or a combination lock of the kind well known by persons of skill in the art. The locking mechanism is preferably further engageable with a latch system on a gym locker for securement thereof.

In one embodiment herein, the chamber of the beverage bottle is hidden or obscured by some sort of cover integrated into the body of the beverage bottle. The second chamber is then accessible via a removable cap or lid.

The latch system is connected to the locking mechanism via a linkage mechanism, allowing a user to control the lock from outside the beverage bottle. To be clear, the locking mechanism is detachable from the second chamber of the beverage bottle and then apply able to the latch of a locker, lock box and the like.

In a preferred embodiment herein, the locking mechanism of the beverage bottle may further comprise an indicator that is visible from the exterior of the beverage bottle, indicating whether the lock is engaged or disengaged.

The beverage bottle herein is preferably made of a durable and lightweight material such as plastic, metal, or some combination thereof.

In an alternative embodiment herein, the second chamber is either partially concealed or substantially not concealed at all. In this embodiment, the locking mechanism is attachable to the body of the bottle either in ready view from the bottle or out of view, for example, beneath the bottle in a concealed, partially concealed or substantially non-concealed second chamber of the bottle.

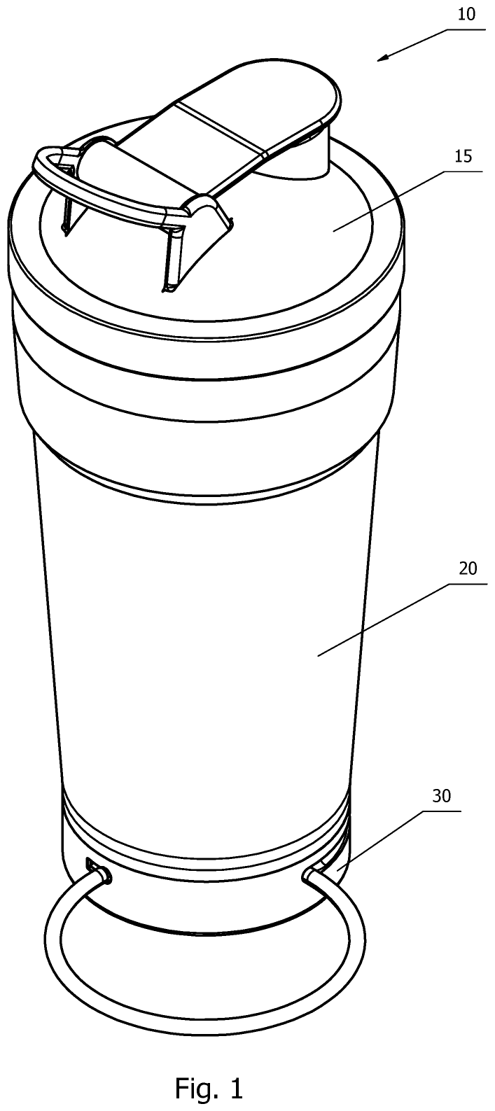

FIG. 1 is a perspective view of one embodiment of the bottle and lock device herein. Bottle and lock device 10 (or device 10) comprises three main parts: lid 15, bottle 20 and locking mechanism 30. Lid 15 and bottle 20 may each be made from high density polyethylene (HDPE), metals like aluminum, steel and composites thereof. Persons of skill in the art will readily recognize the use of these kinds of materials and materials similar thereto including composites thereof.

As shown, locking mechanism 30 is preferably positioned at the bottom of device 10 and also serves as a base upon which device 10 can sent. Ideally, therefore, the bottom side of locking mechanism 30 is planar. Also ideally, locking mechanism 30 is sturdily constructed to bear the weight of device 10 whether empty or full with a consumable liquid. Locking mechanism 30 preferably comprises high density polyethylene, aluminum, steel, two or more metallic composites and the like. The specific composition of locking mechanism 30 is a matter of design choice, but persons of skill will recognize and appreciate that locking mechanism 30 should be sturdy, durable and built for repeated use.

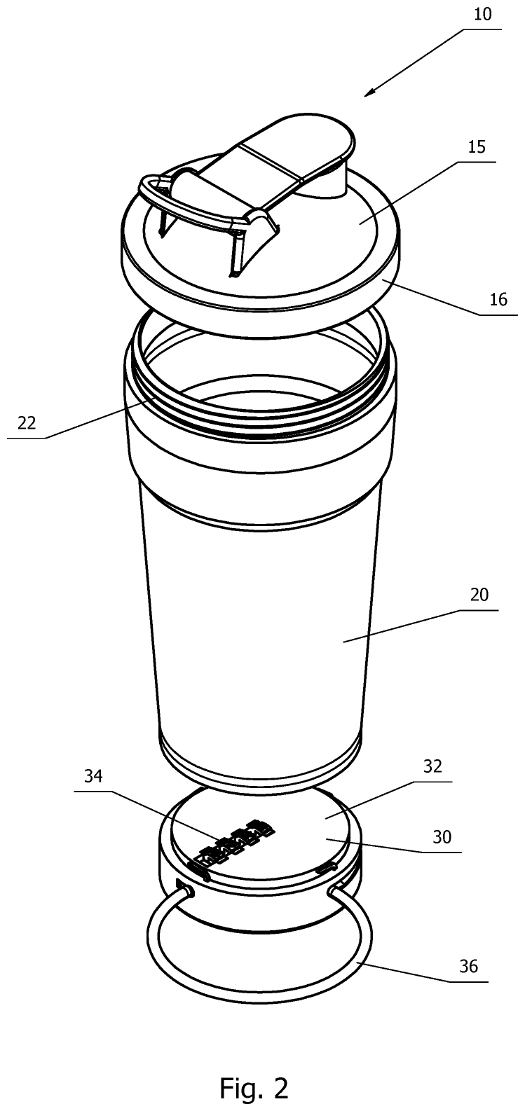

FIG. 2 is an exploded perspective view of the bottle and lock mechanism of FIG. 1. Herein, the major constituent parts are clearly shown: lid 15, bottle 20 and locking mechanism 30. In practice, lid 15 attaches to bottle 20 by a thread mechanism whereby an inner thread mechanism (not shown) resides inside of lip portion 16 of lid 15. The top of bottle 20 comprises an outer thread mechanism that mates with inner thread mechanism 16 by turning lid 15 in a clockwise direction onto the top of bottle 20 thereby matching inner thread mechanism 16 to outer thread mechanism 22.

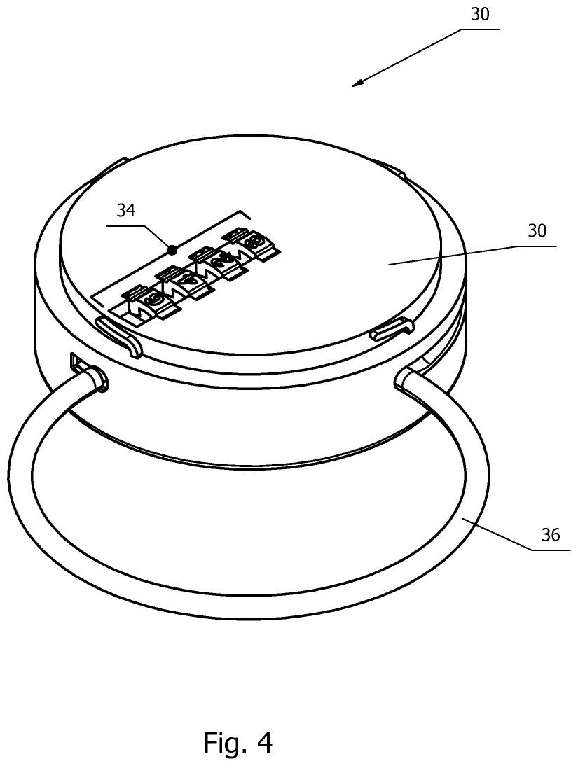

As shown, locking mechanism 30 is a separatable part from device 10. It comprises several constituent parts that will be discussed in full detail hereinbelow in FIG. 4. It is notable now that locking mechanism 30 comprises a top side 32, a bottom side 34 (not shown) opposite to the top side, a lock engagement device 35 and a locking fixture 36 (or cable 36).

It is important to note that while locking mechanism 30 serves as a base for device 10, the bottom of bottle 20 is completely enclosed thereby making device 10 wholly self-contained when locking mechanism 30 is removed therefrom. In its self-contained state, bottle 20 can rest upon its bottom just like similarly formed beverage bottles of its kind can and do.

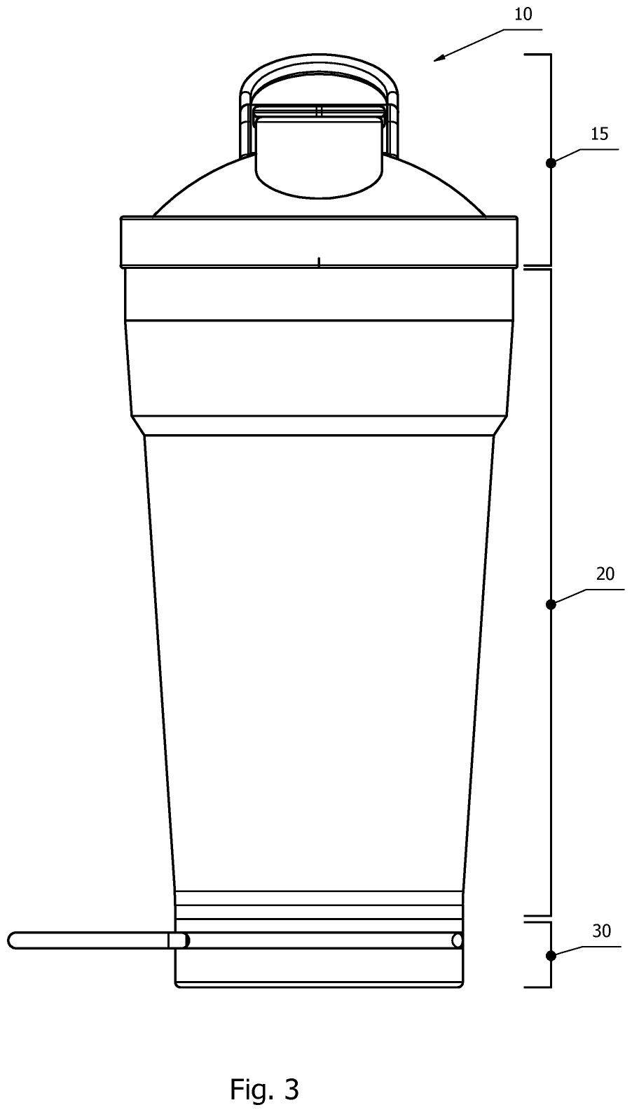

FIG. 3 is a two-dimensional side-view of the bottle and lock mechanism here. Device 10 is shown with lid 15 and bottle 20 sitting atop locking mechanism 30. The preferred locking mechanism 30 herein is a cable lock kind of lock. The cable 36 thereof juts out prominently from locking mechanism 30 as shown.

FIG. 4 is a perspective view of locking mechanism 30 and its major constituent parts: lock mechanism body 31, lock engagement device 35 and locking fixture 36 (or cable 36). As noted hereinabove, a cable lock as shown herein is the preferred locking mechanism herein. A cable lock is a type of portable security device designed to protect belongings from theft or unauthorized access. It consists of a flexible cable made of strong materials like steel or reinforced metal, enclosed within a protective outer covering. The cable's length can vary but is typically long enough to secure items of different sizes.

The design of a cable lock typically includes the following components:
1. Cable: The core element of the lock is the steel cable, that provides the strength and flexibility needed for securing objects. The cable is resistant to cutting and tampering, making it a formidable deterrent against theft attempts.
2. Locking Mechanism: At one end of the cable, there is a locking mechanism that allows the user to secure the cable around objects such as bicycles, laptops, luggage, or other valuable items. The locking mechanism can be in the form of a combination lock, key lock, or even a padlock.
3. Protective Sleeve: The cable is often covered with a protective sleeve, which serves multiple purposes. Firstly, it prevents scratching or damaging the items being secured. Secondly, it adds an extra layer of security by making it harder for potential thieves to access the inner cable.
4. Key or Combination: Some cable locks require a physical key to unlock them, while others use a combination that the owner sets. The combination based locks eliminate the need for carrying keys but require the user to remember the code.

Cable locks are commonly used in various scenarios, including securing bicycles to fixed objects like bike racks or poles, locking up outdoor equipment, securing luggage during travel, and protecting small items in public spaces. They are popular due to their portability and versatility, as they can be easily carried in a bag or attached to the item being protected when not in use.

While cable locks offer a reasonable level of security for deterring opportunistic thieves, it is important to note that determined and well-equipped thieves may still be able to overcome them with specialized tools or techniques. As such, cable locks are best suited for low to moderate-risk environments and should be combined with other security measures for high-value items or in areas prone to theft.

Locking mechanism 30 preferably uses a tumbler kind of lock engagement device 35. Other kinds of lock engagement devices 35 may be used. For example, a finger print coupled with an electronic locking mechanism is also a useful kind of lock engagement device 35 for this execution as is a traditional kind of key and lock mechanism.

As an alternative embodiment to locking mechanism 30 and configuration of device 10 herein, locking mechanism 30 can, instead of being an actual locking mechanism, be a chamber that houses a lock (e.g., a cable lock kind of locking mechanism). In this embodiment, the now chamber can be opened and a lock, which is preferably attached to the inside of the chamber, is removed and then usable for a locker, a door, a bag, a bag or similar such structure in which protectable items may be housed and stored.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods.

Thus, if there are a variety of additional steps that can be performed it is understood that each of these additional steps can be performed with any specific aspect or combination of aspects of the disclosed methods.

The beverage bottle herein with or without a hidden chamber and locking mechanism presented herein combines the functionalities of a beverage container and a gym locker lock. This invention offers convenience and portability while ensuring the security of personal belongings. The above description and claims should not be construed as limiting the scope of the invention, as additional embodiments and variations may be apparent to those skilled in the art.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A beverage bottle, comprising:
a. A body, said body having
i. A first chamber suitable for storing liquid;
ii. A second chamber positioned within said body; and
b. At least one locking mechanism located within said second chamber, said locking mechanism being usable for securing a locker.

2. The beverage bottle of claim 1 wherein said second chamber is concealed from external view.

3. The beverage bottle of claim 1 wherein said locking mechanism comprises a key operated lock or a combination lock, the locking mechanism further engageable with a latch system on a gym locker for securement thereof.

4. The beverage bottle of claim 1 wherein said chamber is hidden or obscured.

5. The beverage bottle of claim 1 wherein said second chamber is accessible via a removable cap or lid.

6. The beverage bottle of claim 1 wherein said latch system is connected to the locking mechanism via a linkage mechanism, allowing a user to control the lock from outside the beverage bottle.

7. The beverage bottle of claim 1 wherein the locking mechanism further comprises an indicator, visible from the exterior of the beverage bottle, indicating whether the lock is engaged or disengaged.

8. The beverage bottle of claim 1 wherein the beverage bottle is made of a durable and lightweight material such as plastic, metal, or some combination thereof.
